(19) United States
(12) Patent Application Publication
(10) Pub. No.: US 2013/0308788 A1
(43) Pub. Date: Nov. 21, 2013

(54) SYSTEM FOR ACCESSING PERSONAL MEDIA DATA IN A REMOTE LOCATION

(71) Applicant: Prabhakar Doddaballapur, Richardson, TX (US)

(72) Inventor: Prabhakar Doddaballapur, Richardson, TX (US)

(21) Appl. No.: 13/894,097

(22) Filed: May 14, 2013

Related U.S. Application Data
(60) Provisional application No. 61/647,227, filed on May 15, 2012.

(51) Int. Cl. H04R 3/00

(52) U.S. Cl. CPC H04R 3/00
USPC 381/74; 381/77

(57) ABSTRACT

A system for listening to personal music at a gym without having to bring a personal media player. The system may include uploading music from a personal computer to a database that is accessed by a second computer used by the gym. The second computer may then wirelessly transmit the uploaded music to a pair of wireless headphones that may be provided by the gym.

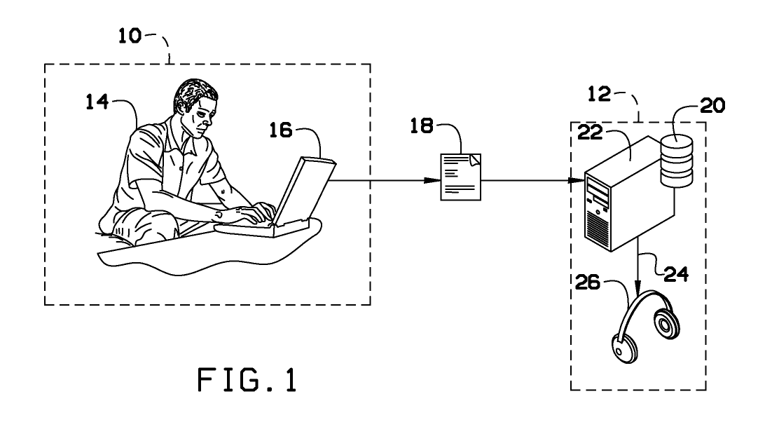

### BACKGROUND OF THE INVENTION

The present invention relates to a system for accessing personal media data in a remote location and, more particularly, to a system for accessing personal music at a gym.

Currently, people tend to go to gyms to exercise. Activities at the gym may include cardiovascular exercises and weight lifting. Typically, people listen to music during their exercise because it may be the best form of entertainment for such activities. Further, the music may drown out surrounding noises and may allow them to concentrate on their workout, or the music may be used to motivate the user.

However, to be able to listen to your own personal music, people have to bring their own MP3 players, smart devices, CD players, tape players and the like to the gym. Holding on to such devices during the workout may be burdensome and the wires may become tangled and in the way. Additionally, people may not have an armband or pockets to hold the devices, may forget to charge the devices, and the more gear that one brings to the gym, the more likely a user may misplace their items.

As can be seen, there is a need for a convenient system for accessing personal music at the gym.

### SUMMARY OF THE INVENTION

In one aspect of the present invention, a system for accessing a personal playlist comprises: a computer having a user interface; and a program product comprising machine-readable program code for causing, when executed, the computer to perform the following process steps: prompting a user to enter an identifier to access a personal account on a first processor; prompting a user to upload media data using the first processor; sending the uploaded media data from the first processor to a database, wherein a second processor in a remote location has access to the database; and transmitting the media data wirelessly from the second processor to a wireless receiver.

In another aspect of the present invention, a method of accessing personal music at a gym comprises: obtaining a username and a password for accessing a program product hosted by the gym; logging into a personal account using the username and password on a first computer that is implementing the program product; uploading music data from the first computer to a database accessed by a second computer at the gym using the program product; producing wireless headphones; and receiving the music data from the second computer to the wireless headphones.

These and other features, aspects and advantages of the present invention will become better understood with reference to the following drawings, description and claims.

### BRIEF DESCRIPTION OF THE DRAWINGS

The FIGURE is a schematic diagram of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for listening to personal music at a gym without having to bring a personal media player. The system may include uploading music from a personal computer to a database that is accessed by a second computer used by the gym. The second computer may then wirelessly transmit the uploaded music to a pair of wireless headphones that may be provided by the gym.

The present invention may provide for an easy way to listen to a personal music collection while at the gym. Users may access their own personal music library while at the gym. More people may enroll with the gym if the gym provides the new technology that provides further convenience for a user. However, the present invention is not limited to the gym and may be used for yoga classes or training centers in schools, colleges, professional sports facilities and the like.

In certain embodiments, the present invention may enable people to have access to their personal music library while working out at the gym, without having to use an mp3 player. The present invention may include a set of wireless headphones that can communicate with gym equipment through a variety of technologies. In certain embodiments, users may enroll at their gym and receive web-service login credentials. The user may then go online and upload their multimedia library, including music files, playlists, podcasts, and videos to a gym database. Users may then go to the gym and may be provided a pair of wireless headphones that may access their particular library via the gym's wireless equipment. The headphones can be provided to users at the beginning of their workout and may be given back at the end. In certain embodiments, the user may bring their own wireless headphones that connect with the gym database. However, this process may vary without parting from the scope of the present invention.

The present invention may include a plurality of computers with a user interface. The computers may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

Referring to the FIGURE, the user 14 may either create an identifier, such as a username and password, or may be given an identifier upon joining the establishment, such as a gym. The user 14 may first login to a website or application using a first computer 16. The user may be at an offsite location 10. The user may then upload their personal media 18 in the form of data to a database 20 associated with the gym, which may be accessed by a second computer 22 located on-site 12 of the gym. The personal media 18 may include, but is not limited to, music files, playlists, podcasts, videos and the like.

Once the user 14 has uploaded the data to the database 22, the user may then listen to their personal media 18 anytime they go to the gym. Further, it is envisioned that the user 14 may listen to a friend's media or any media uploaded to the database 22. In certain embodiments, the music may be accessed on-site 12 by a user. The second computer 22, having access to the database 20, may include a wireless transmitter. Electronic headphones 26 may receive the wireless transmission 24 from the wireless transmitter of the second computer 33. Therefore, a user may enter the on-site area 12, such as the gym, receive a pair of headphones 26 that is wirelessly connected with the second computer 22 and may listen to the media that the user 14 had previously uploaded. The headphones 26 may include wireless adapters, such as Bluetooth® technology.

The present invention may provide people with an easy way to listen to their music collection while at the gym. The present invention may include a pair of headphones that can be wirelessly connected to the gym equipment. Through a personal account, users may access their multimedia library through the equipment, and then listen through the headphones while they work out. By using this product, people may simplify their workout experience by still being able to access their multimedia without having to carry along their own mp3 player.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for accessing a personal playlist comprising:
a computer having a user interface; and
a program product comprising machine-readable program code for causing, when executed, the computer to perform the following process steps:
prompting a user to enter an identifier to access a personal account on a first processor;
prompting a user to upload media data on the first processor;
sending the uploaded media data from the first processor to a database, wherein a second processor in a remote location has access to the database; and
transmitting the media data wirelessly from the second processor to a wireless receiver.

2. The system of claim 1, wherein the media data is selected from the group consisting of music files, playlists, podcasts, and videos.

3. The system of claim 1, wherein the wireless receiver is a wireless headphone set.

4. The system of claim 2, wherein the media data is a playlist comprising music.

5. The system of claim 1, wherein the remote location is a gym.

6. The system of claim 1, wherein the identifier is a username and a password.

7. The system of claim 1, wherein the first and second processors connect with one another via the internet.

8. The system of claim 1, wherein the first processor is selected from the group consisting of a desktop, a laptop, a tablet, and a smart phone.

9. The system of claim 1, wherein the program product is at least one of an application program loaded onto the first and second processors, and a remote website accessed by the first and second processors.

10. The system of claim 9, wherein the first and second processors access the remote website via the internet.

11. A method of accessing personal music at a gym comprising:
obtaining a username and a password for accessing a program product hosted by the gym;
logging into a personal account using the username and password on a first computer that is implementing the program product;
uploading music data from the first computer to a database accessed by a second computer at the gym using the program product;
producing wireless headphones; and
receiving the music data from the second computer to the wireless headphones.

12. The method of claim 11, wherein the program product is at least one of a website and an application.
